(19) United States
(12) Patent Application Publication
(10) Pub. No.: US 2012/0107772 A1
(43) Pub. Date: May 3, 2012

(54) MOUNTING STRUCTURE OF INTERNAL AND EXTERNAL CROWNS

(76) Inventor: TAI-WU LIN, Taipei City (TW)

(21) Appl. No.: 12/939,153

(22) Filed: Nov. 3, 2010

(51) Int. Cl. A61C 13/225

(52) U.S. Cl. 433/172

(57) ABSTRACT

A mounting structure is provided between internal and external crowns of a prosthetic device, in which a tenon-mortise type engagement is formed for fixing the crowns. The internal crown forms an internal coupling section and the external crown forms an external coupling section that corresponds to the internal coupling section. The external coupling section includes a liftable structure, whereby when the external crown is fit to the internal crown, the liftable structure is slightly bulged outward to allow for easy movement of the external crown for fitting to the internal crown. With the inter-engagement between the internal and external coupling sections, the external crown is set stably and securely on the internal crown and problems of insufficient or excessive fitting tightness between the crowns are eliminated or alleviated.

### (a) TECHNICAL FIELD OF THE INVENTION

The present invention generally relates to a mounting structure that mounts internal and external prosthetic crowns with tenon-mortise engagement, and more particularly to a mounting structure for use in an external prosthetic crown that comprises a liftable structure.

### (b) DESCRIPTION OF THE PRIOR ART

Food must be properly chewed before it can be completely digested and absorbed by intestines and stomach. When teeth are removed due to being damaged or showing an excessively large cavity, to maintain proper chewing capability, a denture or prosthetic tooth that comprises an internal crown and an external crown combined and mounted in a removable manner is often provided. Such a prosthetic device helps restoring the chewing capability of a dental patient and is detachable for throughout cleaning.

Such a prosthetic device is installed in such a way that the internal crown is bonded or cemented to a tooth abutment and the outer crown is then fit over the internal crown. A friction force is induced between the internal and external crowns to maintain the fitting engagement between the crowns. To clean the prosthetic device, the external crown is removed for throughout cleaning. Further, when the external crown is worn out or is unexpectedly damaged, the external crown can be removed for maintenance and repairing. Such a dual-crown prosthetic device is commonly used.

However, such a dual-crown prosthetic device suffers insufficient structural stability, for the external and internal crowns are fixed together through friction. When the friction force is insufficient, the external crown may get detached due to a user chewing food stuffs, especially sticky food stuffs. On the other hand, if the friction force is excessive, the external crown may get jammed on the internal crown and hard to remove from the internal crown.

### SUMMARY OF THE INVENTION

To overcome such a problem, the present invention provides a mounting structure of internal and external crowns, wherein an internal crown is bonded to a tooth abutment and forms an internal coupling section, while an external crown is provided with an external coupling section, which is formed to correspond to the internal coupling section, and forms a liftable structure, whereby in fitting the external crown to the internal crown, the liftable structure allows for a slight outward lifting or bulging movement to facilitate performance of relative movement between the external coupling section and the internal coupling section.

The present invention uses the inter-engagement established between the internal coupling section and the external coupling section to secure the external crown on the internal crown without application of complicated structure. The manufacturing process of the prosthetic device is simple. Further, with such an arrangement, the internal and external crows are not simply fixed together with a friction force therebetween. This allows for reduction of fitting tightness between the internal and external crowns in the manufacturing thereof, while the coupling between the internal and external crowns can be maintained stable through the arrangement of the mounting structure provided by the present invention, and meanwhile, the external crown can always be easily removable.

Further, in fitting the external crown to the internal crown, correct relative positioning between the internal and external crowns can be identified through the internal coupling section and the external coupling section. In other words, insufficient or excessive downward movement of the external crown with respect to the internal crown, which leads to accelerated wearing of surfaces of the external and internal crowns, caused by improper control of the downward traveling distance of the external crown in being fit to the internal crown can be fixed and thereby alleviate or eliminate the occurring of such accelerated wearing.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view showing use of an embodiment of the present invention.

FIG. 2 is an exploded view showing use of the embodiment of the present invention.

FIGS. 3 and 4 are cross-sectional views showing the use of the embodiment of the present.

FIGS. 5 and 6 are cross-sectional views showing use of external crown coupling section and internal crown coupling section according to another embodiment of the present invention.

FIG. 7 is an exploded view showing use of external crown coupling section and internal crown coupling section according to a further embodiment of the present invention.

FIG. 8 is a cross-sectional view, in an exploded form, showing use of external crown coupling section and internal crown coupling section according to a further embodiment of the present invention.

FIGS. 9 and 10 are cross-sectional views showing use of external crown coupling section and internal crown coupling section according to a further embodiment of the present invention.

FIGS. 11 and 12 are exploded views showing uses of use of external crown coupling section and internal crown coupling section according to further embodiments of the present invention.

FIG. 13 is a perspective view showing use of an embodiment of the present invention.

FIG. 14 is a perspective view showing a liftable structure according to another embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

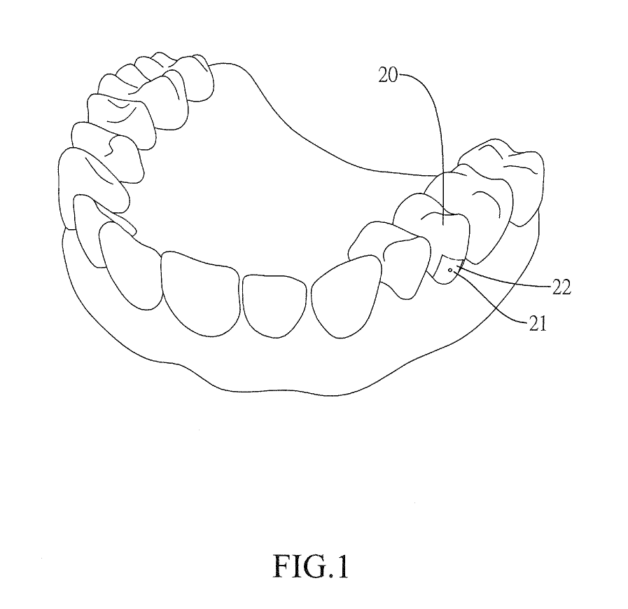

Referring to FIGS. 1-3, the present invention provides a mounting structure of internal and external crowns, which comprises an internal crown 10 and an external crown 20. The internal crown 10 comprises at least one internal crown coupling section 11, and the internal crown coupling section 11 is formed on an outside surface of the internal crown 10. The external crown 20 comprises at least one external crown coupling section 21, and the external crown coupling section 21 is formed to correspond in position to the internal crown coupling section 11. The external crown 20 is processed through for example cutting to form a liftable structure 22, and the external crown coupling section 21 is arranged inside the liftable structure 22. When the external crown 20 is fit over the internal crown 10, the external crown coupling section 21 and the internal crown coupling section 11 are allowed to engage each other to have the external crown 20 stably fixed on the internal crown 10. Further, the internal crown coupling section 11 and the external crown coupling section 21 can be formed on surfaces that face cheek or tongue, or that is close to or away from the center. For easy explanation and illustration, the two coupling sections are shown in the front side, but the arrangement of the coupling sections is not limited to such a situation.

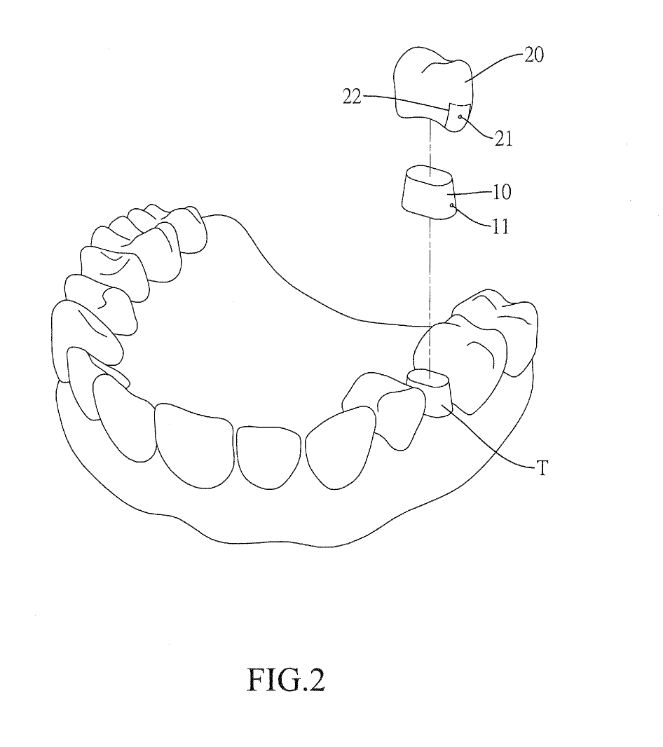

Referring to FIGS. 2-4, the instant embodiment is provided to fit to a tooth T. Once the tooth T to which the embodiment is applied has been properly treated, the internal crown 10 is bonded to the tooth T and then the external crown 20 is mounted in an up-down direction. During the process, with the liftable structure 22 being actuated to slightly lift the external crown coupling section 21 outward, the external crown coupling section 21 is allowed to reach a predetermined site without excessive resistance. Afterwards, the liftable structure 22 is allowed to close back so as to set the external crown coupling section 21 and the internal crown coupling section 11 engaging each other to thereby complete the process of installation.

During the process of installation, the liftable structure 22 is only slightly lifted to allow the external crown coupling section 21 to move downward smoothly without being blocked and resisted. Thus, the liftable structure 22 is made slightly resilient, whereby when an external force applied thereto for lifting is removed, the liftable structure 22 is allowed to spring back and thus returns to the original position. This facilitates the convenience of use.

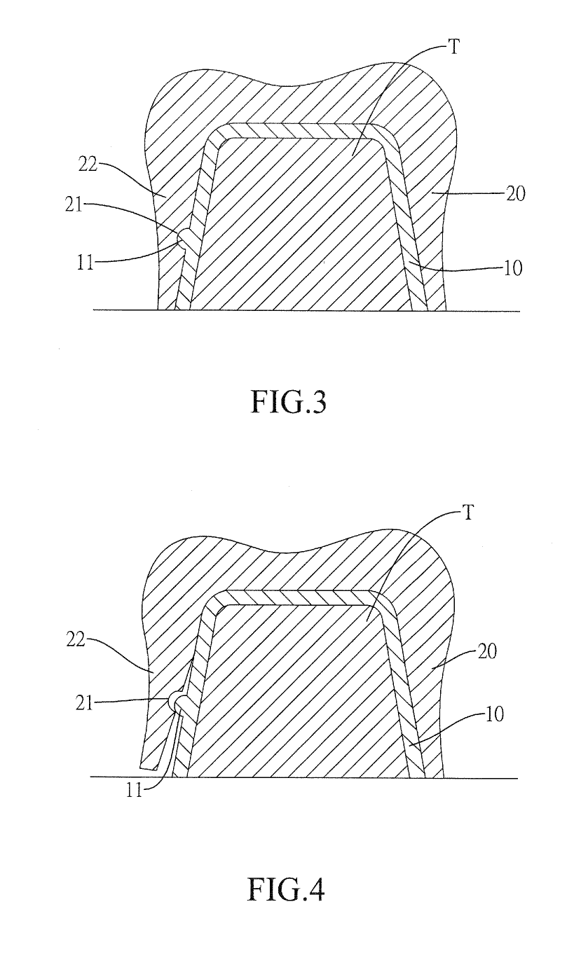

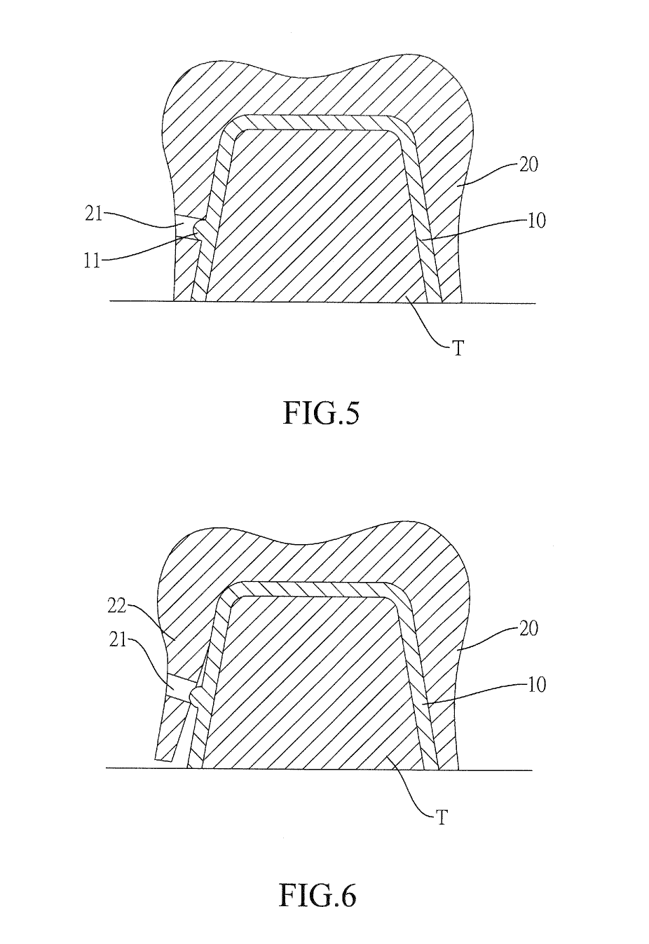

As shown in FIGS. 3 and 4, the internal crown coupling section 11 can be made in the form of a raised spot, while the external crown coupling section 21 is a recess, such as a dimple, corresponding to the raised spot. Alternatively, as shown in FIGS. 5 and 6, the external crown coupling section 21 is made in the form of a through hole, and the internal crown coupling section 11 can be received in the through hole or the dimple to realize an effect of proper positioning. Further, the raised spot and the dimple may be of a circular shape, a triangular shape, or an arbitrary polygonal shape, all being effective in realizing the effect of coupling.

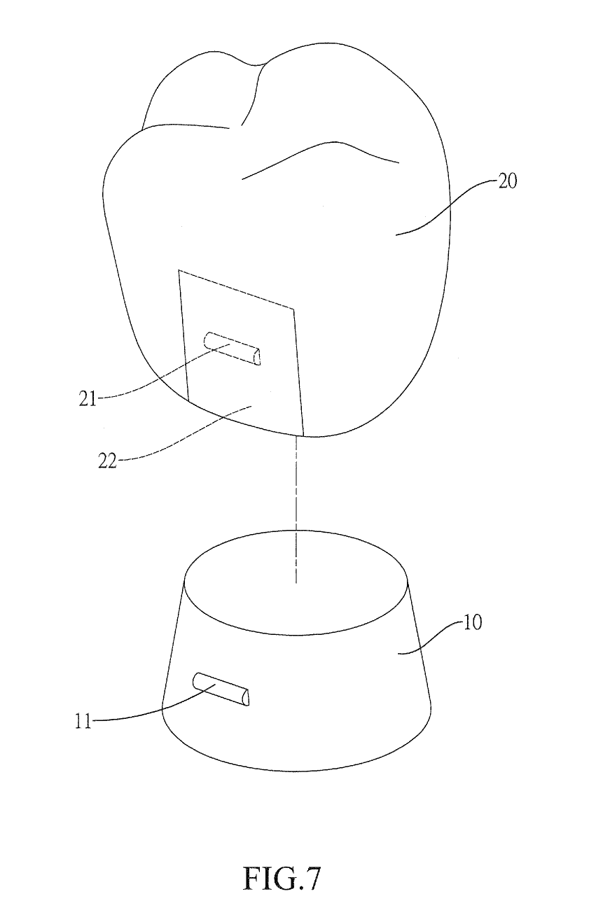

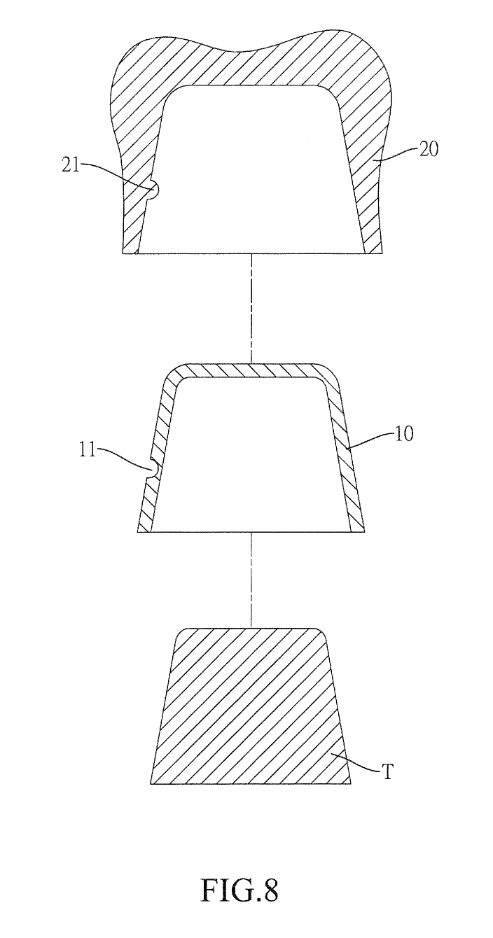

Referring to FIG. 7, a different embodiment is provided, wherein the internal crown coupling section 11 is made in the form of a raised rib, while the external crown coupling section 21 is a channel corresponding to the raised rib. This arrangement helps increasing the area of engagement and thus improving the effectiveness of positioning and fixing. In other words, the force that fixes the external crown 20 to the internal crown 10 is increased to prevent the crown from being unexpectedly detached due to being stuck by sticky substances.

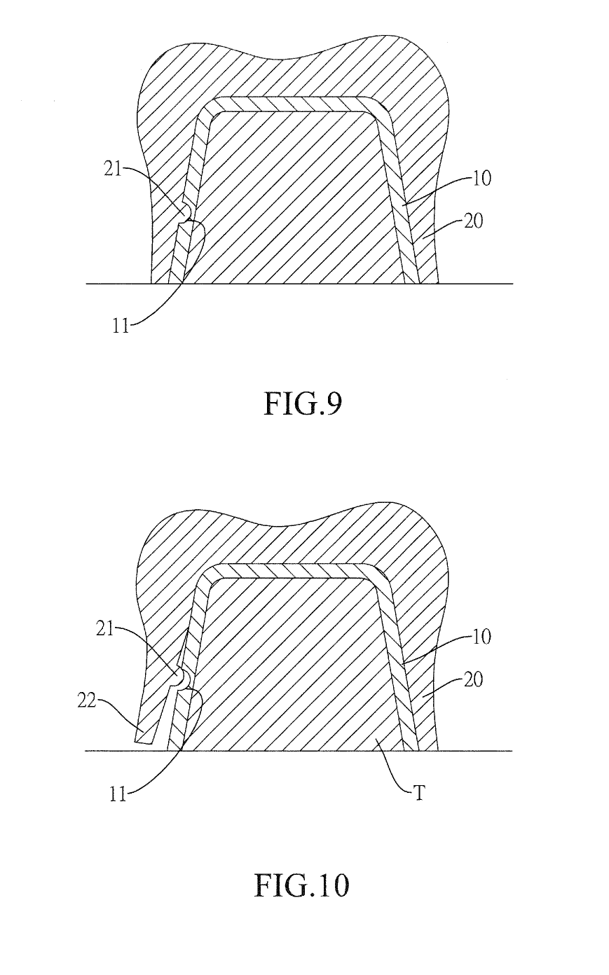

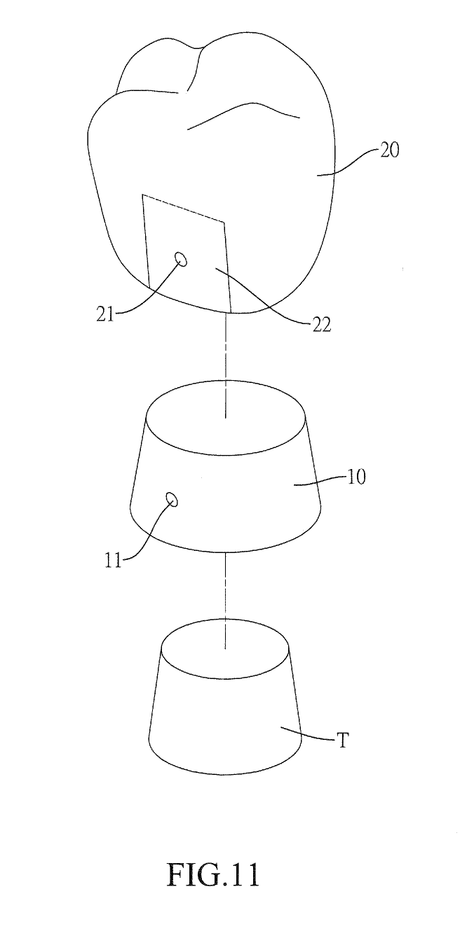

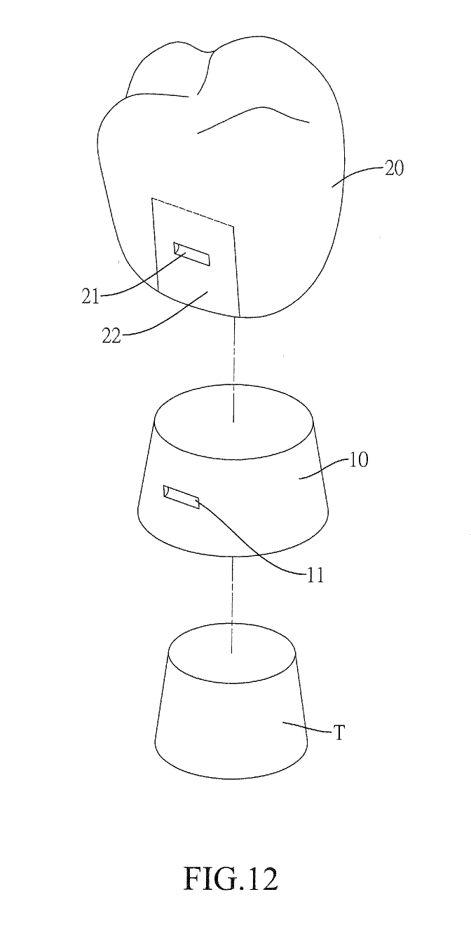

Referring to FIGS. 8-11, a further embodiment is shown, wherein the internal crown coupling section 11 comprises a dimple, while the external crown coupling section 21 comprises a raised spot facing inward. This arrangement helps improving smoothness of relative movement of the external crown 20 moving downward to fit to the internal crown 10. Alternatively, as shown in FIG. 12, the internal crown coupling section 11 can be made in the form of an elongate channel, while the external crown coupling section 21 comprises a raised rib corresponding to the channel for the purposes of increasing the effectiveness of positioning and fixing. Further, the raised spot and the dimple can be of a circular shape, a triangular shape, or any arbitrary polygonal shape, all being effective in realizing the effect of coupling.

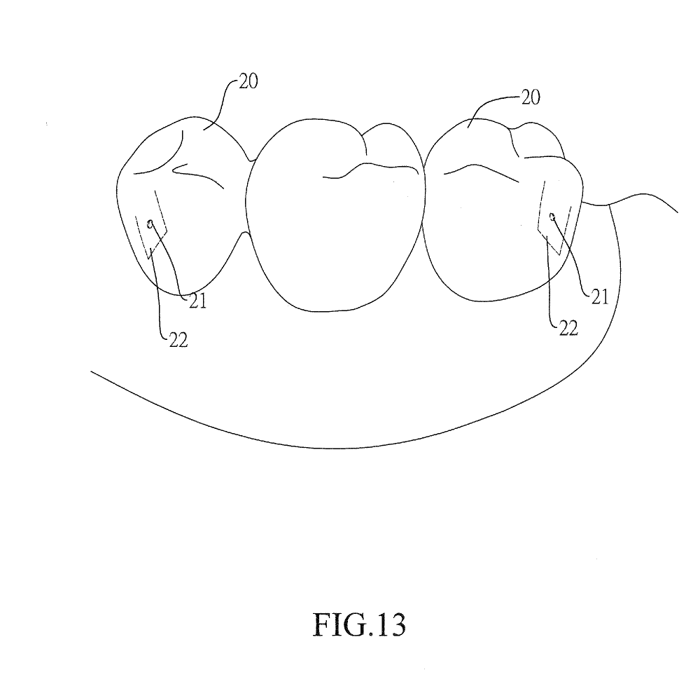

Referring to FIG. 13, for applications in various situations, such as a denture or bridge of a single tooth unit, two tooth units, or three tooth units, in which two side members are used to support a central prosthetic tooth with the central prosthetic tooth being welded to the side support members at upper portions thereof to form a bridge that provides improved support to the central prosthetic tooth, as shown in the drawing, under such a situation, the external crown coupling section 21 can be formed on a lower portion of the welding between the teeth or on an opposite outer side. By placing the internal crown coupling section 11 and the external crown coupling section 21 in the locations between teeth, aesthetic effect and tongue comfort are simultaneously achieved. Further, FIG. 13 provides an example in which a device of three tooth units is provided for description, yet it is apparent other arrangements of various tooth units may also be used and expected.

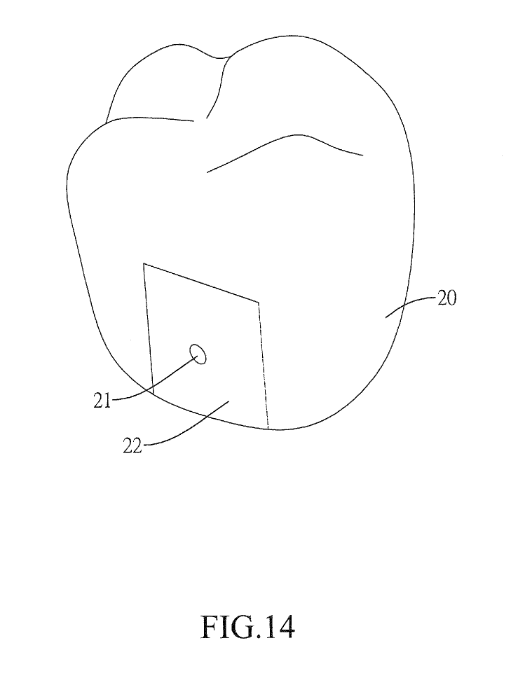

Referring to FIG. 14, the liftable structure 22 can be arranged in a laterally openable manner and adjustment may be practiced by a dentist as desired.

In summary, the present invention uses the inter-engagement relationship between the internal crown coupling section and the external crown coupling section to realize stabilized coupling between the internal crown and the external crown and also uses such a coupling engagement between the two coupling sections to reduce the frictional force and fitting tightness between the internal and external crowns so as to allow for assured easy removal of the external crown from the internal crown.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

1. A mounting structure of internal and external crowns, comprising:
an internal crown, which comprises at least one internal crown coupling section, the internal crown coupling section being formed on a surface of the internal crown; and
an external crown, which comprises at least one external crown coupling section, the external crown coupling section being formed to correspond to the internal crown coupling section, the external crown being cut to form a resilient liftable structure which is allowed to spring back and return to original position when an external force applied to the resilient liftable structure is removed, the external crown coupling section being arranged inside the resilient liftable structure;
wherein when the external crown is fit to the internal crown, the external crown coupling section and the internal crown coupling section engage each other.

2. The mounting structure of internal and external crowns according to claim 1, wherein the internal crown coupling section comprises a raised portion, while the external crown coupling section comprises a dimple or a through hole corresponding in position to the raised portion.

3. The mounting structure of internal and external crowns according to claim 2, wherein the raised portion comprises an elongate rib and the dimple is elongate.

4. The mounting structure of internal and external crowns according to claim 1, wherein the internal crown coupling section comprises a dimple and the external crown coupling section comprises a raised portion.

5. The mounting structure of internal and external crowns according to claim 4, wherein the raised portion comprises an elongate rib and the dimple is elongate.
